(19) United States
(12) Patent Application Publication
(10) Pub. No.: US 2014/0266556 A1
(43) Pub. Date: Sep. 18, 2014

(54) CORE TUBE FOR A TRANSFORMER AND AN ASSOCIATED METHOD THEREOF

(71) Applicant: GENERAL ELECTRIC COMPANY, Schenectady, NY (US)

(72) Inventors: John Raymond Krahn, Schenectady, NY (US); Manoj Ramprasad Shah, Latham, NY (US); Oscar Ruiz Martinez, Apodaca (MX)

(73) Assignee: GENERAL ELECTRIC COMPANY, Schenectady, NY (US)

(21) Appl. No.: 13/841,033

(22) Filed: Mar. 15, 2013

(51) Int. Cl. H01F 3/10; H01F 27/24; H01F 41/02

(52) U.S. Cl. CPC H01F 3/10; H01F 41/0206; H01F 27/24
USPC 336/220; 29/602.1; 336/233

(57) ABSTRACT

A core tube for a transformer is disclosed. The core tube includes a first half portion and a second half portion. The first half portion includes a first side portion, a first joining portion, and a second side portion. The first side portion is coupled to the second side portion via the first joining portion. The first side portion is longer than the second side portion or vice versa. The second half portion includes a third side portion, a second joining portion, and a fourth side portion. The third side portion is coupled to the fourth side portion via the second joining portion. The third side portion is longer than the fourth side portion or vice versa. The first half portion is coupled to the second half portion in an interleaved manner.

### BACKGROUND

The disclosure relates generally to electrical machines, and more particularly to a core tube of a transformer, for example.

Electrical machines, such as a transformer have a core, and a plurality of windings surrounding the core. The transformer is used to transfer electrical energy by inductive coupling between the plurality of windings and the core. In some transformers, a core tube is used to provide insulation between the core and the plurality of windings, so as to improve the service life of the plurality of windings and the core. The core tube is made of electrically insulating materials, such as electrical paper, and is preferably interposed between the windings and the core.

In certain examples, the core tube is formed by folding a one-piece material to form a hollow tube. Such a core tube design creates gaps between the core tube and the core, and/or between the core tube and the plurality of windings. During a short-circuit event and/or during testing, the windings may shift, distort, and deform due to the presence of the gaps. Additionally, the overlapping ends of the core tube may result in non-uniform stress distribution around the core of the transformer. The deformation of the windings may weaken the insulation capability of the core tube and may alter the electrical clearances in an undesirable manner.

Thus, there is a need for an enhanced core tube for a transformer.

### BRIEF DESCRIPTION

In accordance with one exemplary embodiment, a core tube for a transformer is disclosed. The core tube includes a first half portion having a first side portion, a first joining portion, and a second side portion. The first side portion is coupled to the second side portion via the first joining portion. The first side portion is longer than the second side portion or vice versa. Further, the core tube includes a second half portion having a third side portion, a second joining portion, and a fourth side portion. The third side portion is coupled to the fourth side portion via the second joining portion. The third side portion is longer than the fourth side portion or vice versa. The first half portion is coupled to the second half portion in an interleaved manner to form the core tube.

In accordance with another exemplary embodiment, a transformer is disclosed. The transformer includes a core, a core tube, and a plurality of windings wound around the core tube. The plurality of windings includes at least one primary winding and at least one secondary winding. The core tube includes a first half portion having a first side portion, a first joining portion, and a second side portion. The first side portion is coupled to the second side portion via the first joining portion. The first side portion is longer than the second side portion or vice versa. Further, the core tube includes a second half portion having a third side portion, a second joining portion, and a fourth side portion. The third side portion is coupled to the fourth side portion via the second joining portion. The third side portion is longer than the fourth side portion or vice versa. The first half portion is coupled to the second half portion in an interleaved manner to form the core tube.

In accordance with one embodiment, a method of assembling a core tube for a transformer is disclosed. The method includes disposing a first half portion and a second half portion of the core tube, surrounding a core. Further, the method includes coupling the first half portion to the second half portion in an interleaved manner. The core tube includes a first half portion having a first side portion, a first joining portion, and a second side portion. The first side portion is coupled to the second side portion via the first joining portion. The first side portion is longer than the second side portion or vice versa. Further, the core tube includes a second half portion having a third side portion, a second joining portion, and a fourth side portion. The third side portion is coupled to the fourth side portion via the second joining portion. The third side portion is longer than the fourth side portion or vice versa. The first half portion is coupled to the second half portion in an interleaved manner to form the core tube.

In accordance with another embodiment, a method of manufacturing a core tube for a transformer is disclosed. The method includes manufacturing a plurality of halve portions. The method includes manufacturing each half portion having one side portion, a joining portion, and another side portion. Further, the method includes coupling the one side portion to the other side portion via the joining portion. The method includes manufacturing the one side portion longer than the other side portion or vice versa. Further, the method includes manufacturing each among the one side portion and the other side portion having a first width and the joining portion having a second width twice the first width.

### DRAWINGS

These and other features and aspects of embodiments of the present disclosure will become better understood when the following detailed description is read with reference to the accompanying drawings in which like characters represent like parts throughout the drawings, wherein:

FIG. 1a is an isometric view of a transformer having a core, a primary winding, a secondary winding, a support bracket, and a core tube in accordance with one exemplary embodiment;

FIG. 1b is an isometric view of an assembled transformer in accordance with one exemplary embodiment;

FIG. 2a is a sectional view of a conventional transformer having a core tube disposed between a core and a winding;

FIG. 2b is diagrammatic illustration of a conventional transformer having a core tube which is subjected to testing and/or short circuit;

FIG. 3 is a sectional view of a transformer having a core tube disposed between a core and a winding in accordance with one exemplary embodiment;

FIG. 4a is a diagrammatic illustration of a first half portion of a core tube in accordance with one exemplary embodiment;

FIG. 4b is a diagrammatic illustration of a second half portion of the core tube in accordance with the exemplary embodiment of FIG. 4a;

FIG. 4c is a diagrammatic illustration of the core tube in accordance with the exemplary embodiment of FIGS. 4a and 4b;

FIG. 5a is a diagrammatic illustration of a first half portion of a core tube in accordance with another exemplary embodiment;

FIG. 5b is a diagrammatic illustration of a second half portion of the core tube in accordance with the exemplary embodiment of FIG. 5a;

FIG. 5c is a diagrammatic illustration of the core tube in accordance with the exemplary embodiments of FIGS. 5a and 5b; and

FIG. 6 is a diagrammatic illustration of a core tube in accordance with yet another exemplary embodiment.

### DETAILED DESCRIPTION

While only certain features of embodiments of the invention have been illustrated and described herein, many modifications and changes will occur to those skilled in the art. It is, therefore, to be understood that the appended claims are intended to cover all such modifications and changes as fall within the true spirit of the invention.

Embodiments discussed herein disclose a core tube used in a transformer. More particularly, certain embodiments of the present disclosure disclose a core tube disposed around a core, and a plurality of windings wound around the core tube of a transformer. The core tube includes a first half portion and a second half portion and in some embodiments the first half and second half have a U-shape. The first and the second half portions are detachably coupled in an interleaved manner to form the core tube.

More specifically, certain embodiments of the present disclosure disclose a method of fabricating a core tube for a transformer. In one embodiment, two halve portions of a core tube are extruded using extrusion techniques such as profile-extrusion of thermoplastics. In another embodiment, the two halve portions of the core tube are molded using compression molding techniques such as compression molding of thermosets. In yet another embodiment, the two halve portions of the core tube are formed using thermoforming techniques such as thermoforming of thermoplastics or sheet-stock. Each half portion includes one side portion, a joining portion, and another side portion coupled to the one side portion via the joining portion. Further, the one side portion is longer than the other side portion. Additionally, each among the one side portion and the other side portion has a first width and the joining portion has a second width twice the first width. In certain other embodiments, each among the first side portion and the second side portion of the core tube is tapered from proximate end to distal end.

FIG. 1a illustrates isometric view of a transformer 100 in accordance with one exemplary embodiment. In the illustrated embodiment, the transformer 100 includes a first core 102, a second core 132, a plurality of windings 104, 106, a plurality of spacers 130, a plurality of end shields 134, an oil duct 105, a core tube 110, and power source connectors 111, 113. The transformer 100 illustrated in FIG. 1a is a single phase distribution transformer. It should be noted that other types of transformers having different phases and types are also envisioned, without limiting the scope of the invention. The first core 102 includes a first vertical portion 112a, a second vertical portion 116a, a first horizontal portion 114a, a second horizontal portion 118a, and a first core window 120a. The second core 132 includes a first vertical portion 112b, a second vertical portion 116b, a first horizontal portion 114b, a second horizontal portion 118b, and a first core window 120b. The first and second cores 102, 132 may be made of a material that has a high magnetic permeability, such as iron and is typically laminated with sheets of iron. The first and second cores 102, 132 in some examples are a step core or a shell core. The shape of the first and second cores 102, 132 may be rectangular, polygonal, or the like.

The primary winding 104 includes a first leg 122 and a second leg 126. The secondary winding 106 includes a first leg 124 and a second leg 128. The illustrated embodiment has one primary winding 104 and one secondary winding 106. The primary winding 104 is disposed surrounding the core tube 110. The secondary winding 106 is concentrically disposed surrounding the primary winding 104. The oil duct 105 is disposed in-between the primary and secondary windings 104, 106. The windings 104, 106 are typically made of conductive material such as a copper wire.

The core tube 110 includes an outer surface 136 over which the primary winding 104 is wound. The core tube 110 is made of materials having good dielectric strength such as cellulose paper, for example. Further, each spacer 130 is used to separate the primary and secondary windings 104, 106, thus allowing the oil duct 105 to cool each of the windings 104, 106. The power source connector 111 is coupled to the primary winding 104 and the power source connector 113 is coupled to the secondary winding 106. Each end shield 134 is used to shield the core tube 110, the primary winding 104, and the secondary winding 106.

FIG. 1b illustrates an isometric view of an assembled transformer in accordance with one exemplary embodiment. In one embodiment, the first core 102 is cut into two halves along middle of the first horizontal portion 114a and the second horizontal portion 118a. Similarly, the second core 132 is cut into two halves along the middle of the first horizontal portion 114b and the second horizontal portion 118b. The first core 102 and the second core 132 are wound around legs 122, 126, 124, 128 of the windings 104, 106 via the first center portion 120a, 120b respectively. In such embodiments, the plurality of spacers 130 is inserted between the windings 104, 106 so as to allow the oil duct to cool the windings 104, 106. The plurality of end shields 134 are disposed over the core tube 110, the primary winding 104, and the secondary winding 106 to shield from the environment.

During operation, a power source (not shown) is coupled to the power source connector 111 and supplies electrical energy to the primary winding 104. The supplied electrical energy creates a varying magnetic flux in the first core 102 and second core 132 of the transformer 100. The varying magnetic flux induces a “voltage” in the secondary winding 106. Electrical energy is then delivered via the power source connector 113, typically to a load (not shown).

In the illustrated embodiment, a sectional view A-A formed along a center of the primary winding 104, the core tube 110, and along the core 102 is used to discuss further details with reference to subsequent figures.

FIG. 2a is a sectional view of a conventional transformer 200 having a core tube 210 disposed between a core 202 and a winding 204. The core tube 210 is a one-piece material having two distinct ends 240, 242. The core tube 210 is formed by folding the one-piece material, such that the ends 240, 242 are overlapped to form a hollow tube. Such core tube design results in the formation of a gap 246 between the core tube 210 and the core 202, and also a gap 248 between the core tube 210 and the winding 204. Additionally, the overlapping of the ends 240, 242 results in non-uniform stress distribution along the core 202 and the winding 204.

FIG. 2b is a diagrammatic illustration of the conventional transformer 200 having the core tube 210. When the transformer 200 is subjected to testing and/or a short circuit event, the winding 204 is shifted, distorted, and deformed wholly or partially due to the presence of gaps 246, 248. The core tube 210 is subjected to varied force distribution, during short circuit events, resulting in the deformations 254 of the winding 204. The deformations 254 in the winding 204 may disrupt the capability of the insulation system (locally) and therefore result in a dielectric failure. The dielectric failure may lead to improper performance or complete failure of the transformer.

FIG. 3 illustrates a sectional view of the transformer 100 having the core tube 110 disposed between the core 102 and the winding 106. In the illustrated embodiment, the core tube 110 includes a first half portion 156 and a second half portion 158. The first half portion 156 includes a first side portion 160, a second side portion 162, and a first joining portion 164. The first side portion 160 is coupled to the second side portion 162 via the first joining portion 164. Similarly, the second half portion 158 includes a third side portion 166, a fourth side portion 168, and a second joining portion 170. The third side portion 166 is coupled to the fourth side portion 168 via the second joining portion 170. In this embodiment, each of the first half portion 156 and the second half portion 158 have a U-shape.

In the illustrated embodiment, the first side portion 160 is longer than the second side portion 162. In some other embodiments, the length of the first side portion 160 may be smaller than the length of the second side portion 162. In the illustrated embodiment, length “L-1SP” of the first side portion 160 is longer than length “L-2SP” of the second side portion 162. In one illustrative embodiment, the length “L-1SP” of the first side portion 160 is 120 mm and the length “L-2SP” of the second side portion 162 is 110 mm. The length values of the first and second side portions 160, 162 discussed herein should not be construed as a limitation and are provided for exemplary purposes. The length of the first side portion 160 and the second side portion 162 may vary depending on the application and design criteria. Similarly, in the illustrated embodiment, the third side portion 166 is shorter than the fourth side portion 168. In some other embodiments, the length of the third side portion 166 may be longer than the length of the fourth side portion 168. In the illustrated embodiment, the length “L-3SP” of the third side portion 166 is smaller than the length “L-4SP” of the fourth side portion 168. In one illustrative embodiment, the length “L-3SP” of the third side portion 166 is 110 mm and the length “L-4SP” of the fourth side portion 168 is 120 mm. The length values of the third and fourth side portions 166, 168 discussed herein should not be construed as a limitation and are provided for exemplary purposes. The length of the third side portion 166 and the fourth side portion 168 may vary depending on the application and design criteria.

In one embodiment, the width of the first side portion 160 and the second side portion 162 is approximately uniform. In some other embodiments, the width of the first side portion 160 and the second side portion 162 may vary. In the illustrated embodiment, width “W-1SP” of the first side portion 160 and width “W-2SP” of the second side 162 are uniform. In one example, the width “W-1SP” of the first side portion 160 is 10 mm and the width “W-2SP” of the second side portion 162 is 10 mm. The width values of the first and second side portions 160, 162 discussed herein should not be construed as a limitation and are provided for exemplary purposes. The width of the first side portion 160, and the second side portion 162 may vary depending on the application and design criteria. Similarly, in one embodiment, the width of the third side portion 166 and the second side portion 168 is uniform. In some other embodiments, the width of the third side portion 166 and the fourth side portion 168 may vary. In the illustrated embodiment, width “W-3SP” of the third side portion 166 and width “W-4SP” of the fourth side 168 are uniform. In one example, the width “W-3SP” of the third side portion 166 and the width “W-4SP” of the second side portion 168 is 10 mm. The width values of the third and fourth side portions 166, 168 discussed herein should not be construed as a limitation and are provided for exemplary purposes. The width of the third side portion 166 and the fourth side portion 168 may vary depending on the application and design criteria.

In the illustrated embodiment, the first side portion 160 is coupled to an end portion 172 of the first joining portion 164. Similarly, the second side portion 162 is coupled to another end portion 174 of the first joining portion 164. In one embodiment, length of the first joining portion 164 is equal to the length “L-1SP” of the first side portion 160 and the length “L-4SP” of the fourth side portion 168. In one embodiment, width of the first joining portion 164 is equal to the cumulative width “W-1SP”, “W-2SP” of the first side portion 160, and the second side portion 162 respectively. In another embodiment, width of the first joining portion 164 is equal to the cumulative width “W-3SP”, “W-4SP” of the third side portion 166, and the fourth side portion 168 respectively. The length and width of the first joining portion 164 may vary depending on the application and design criteria. In the illustrated embodiment, the first joining portion 164 has a length “L-1JP” and width “W-1JP”. In one example, the length “L-1JP” of the first joining portion is 120 mm and the width “W-1JP” is equal to 20 mm. The length and width values of the first joining portion 164 discussed herein should not be construed as a limitation and are provided for exemplary purposes.

In the illustrated embodiment, the third side portion 166 is coupled to an end portion 176 of the second joining portion 170. Similarly, the fourth side portion 168 is coupled to another end portion 178 of the second joining portion 170. In one embodiment, length of the second joining portion 170 is equal to the length “L-1SP” of the first side portion 160 and the length “L-4SP” of the fourth side portion 168. In one embodiment, width of the second joining portion 170 is equal to the cumulative width “W-1SP”, “W-2SP” of the first side portion 160, and the second side portion 162 respectively. In another embodiment, width of the second joining portion 170 is equal to the cumulative width “W-3SP”, “W-4SP” of the third side portion 166, and the fourth side portion 168 respectively. The length and width of the second joining portion 170 may vary depending on the application and design criteria. In the illustrated embodiment, the second joining portion 170 has a length “L-2JP” and width “W-2JP”. In one example, the length “L-2JP” of the second joining portion 170 is 120 mm and the width “W-2JP” of the second joining portion 170 is equal to 20 mm. The length and width of the second joining portion 170 discussed herein should not be construed as a limitation and are provided for exemplary purposes.

In some embodiments, the width “W-1SP”, “W-2SP” “W-3SP”, “W-4SP” of the first side portion 160, the second side portion 162 the third side portion, and the fourth side portion 160, 162, 166, 168 may be referred to as the “first width”. In certain embodiments, the width “W-1JP” of the first joining portion 164 and the width “W-2JP” of the second joining portion 170 may be referred to as a “second width”. In such embodiments, the second width “W-1JP” “W-2JP” is twice the first width “W-1SP”, “W-2SP” and/or “W-3SP”, “W-4SP”.

In one embodiment, the first side portion 160, the first joining portion 164, and the second side portion 162 of the first half portion 156 together form a U-shape. Similarly, the third side portion 166, the second joining portion 170, and the fourth side portion 168 of the second half portion 158 together form a U-shape. In accordance with one embodiment, the first half portion 156 and the second half portion 158 includes thermoplastics or thermosets. The thermoplastics may be constituted by materials including at least one of a polyetherimide, a polyimide, a polyphenylene sulfide, a polyethylene terephthalate, and a polyethylene napthalate. The thermosets may be constituted by materials including at least one of an epoxy, a silicone, a polyurethane, and a polyester.

In one embodiment, during assembling the transformer 100, the first side portion 160 is inserted from a first portion 102a of the core 102 and the second side portion 162 is inserted from a second portion 102b of the core 102. The first half portion 156 is detachably coupled to the second half portion 158, surrounding the core 102 in an interleaved manner. In one embodiment, the first half portion 156 slides relative to the second half portion 158 to detachably couple the first half portion 156 to the second half portion 158 in the interleaved manner, or vice versa. In such embodiments, the first side portion 160, the second side portion 162, the third side portion 166, and the fourth side portion 168 are tapered from proximate end to distal end. The side portions 160, 162, 166, 168 having tapered cross section are explained in greater detail below. In the illustrated embodiment, the interleaved manner includes coupling the first side portion 160 disposed outside and overlapping relative to the third side portion 166 and coupling the second side portion 162 disposed inside and overlapping relative to the fourth side portion 168. In another embodiment, the interleaved manner (illustrated in FIG. 4a) includes coupling the first side portion 160 disposed inside and overlapping relative to the third side portion 166 and coupling the second side portion 162 disposed outside and overlapping relative to the fourth side portion 168. The windings 104 are wound around the core tube 110 to assemble the transformer 100. The coupling may be made detachable by using fasteners such as nuts and bold, welding, adhesive, for example. The detachable coupling used in this embodiment enables users to easily disassemble the core tube 110 during inspection and repair.

FIG. 4a is a diagrammatic illustration of the first half portion 156 of the core tube 110 in accordance with one exemplary embodiment. In one embodiment, the first half portion 156 is extruded using techniques such as profile-extrusion of thermoplastics, for example. In other embodiment, the first half portion 156 is molded using techniques such as compression molding of thermosets, for example. Similarly, in yet another embodiment, the first half portion 156 is formed using techniques such as thermoforming of thermoplastics or sheet-stock, for example. The first half portion 156 includes the first side portion 160, the second side portion 162, and the first joining portion 164. The first side portion 160 is coupled to the second side portion 162 via the first joining portion 164. The first side portion 160 is longer than the second side portion 162. In the illustrated embodiment, the first side portion 160 is longer by “D-12SP” in comparison with the second side portion 162. Each of the first side portion 160 and the second side portion 162 have a first width “FW” and the first joining portion 164 has a second width “SW”. The second width “SW” is twice the first width “FW”. The first side portion 160, the first joining portion 164, and the second side portion 162 of the first half portion 156 together form a U-shape.

FIG. 4b is a diagrammatic illustration of the second half portion 158 of the core tube 110 in accordance with the exemplary embodiment of FIG. 4a. In one embodiment, the second half portion 158 is extruded using techniques such as profile-extrusion of thermoplastics, for example. In another embodiment, the second half portion 158 is molded using techniques such as compression molding of thermosets, for example. Similarly, in yet another embodiment, the second half portion 158 is formed using techniques such as thermoforming of thermoplastics or sheet-stock, for example. The second half portion 158 has the third side portion 166, the fourth side portion 168, and the second joining portion 170. The third side portion 166 is coupled to the second side portion 168 via the second joining portion 170. The third side portion 166 is shorter than the fourth side portion 168. The fourth side portion 168 is longer by “D-34SP” in comparison with the third side portion 166. Each of the third side portion 166 and the fourth side portion 168 have the first width “FW” and the second joining portion 170 has the second width “SW”. The second width “SW” is twice the first width “FW”. The third side portion 166, the second joining portion 170, and the fourth side portion 168 of the second half portion 158 together form a U-shape. The edges of the first half portion 156 and the second half portion 158 have a right angled profile.

FIG. 4c is a diagrammatic illustration of the core tube 110 assembled in an interleaved manner in accordance with the exemplary embodiments of FIGS. 4a and 4b. In the illustrated embodiment, the core tube 110 is formed by detachably coupling the first half portion 156 to the second half portion 158 in the interleaved manner. In the illustrated embodiment, the interleaved manner includes coupling the first side portion 160 disposed inside and overlapping relative to the third side portion 166 and coupling the second side portion 162 disposed outside and overlapping relative to the fourth side portion 168. While FIGS. 4a-4c show the final core tube 110 formed as a rectangle, other shapes are contemplated, including a square.

FIG. 5a is a diagrammatic illustration of a first half portion 256 of a core tube in accordance with another exemplary embodiment. The first half portion 256 includes a first side portion 260, a second side portion 262, and a first joining portion 264. The first side portion 260 is coupled to the second side portion 262 via the first joining portion 264. The first half portion 256 has a U-shape having a smooth profile. The profile and shape of the first half portion 256 may vary depending on the profile of the core and the type of transformer.

FIG. 5b is a diagrammatic illustration of a second half portion 258 of a core tube in accordance with the exemplary embodiment of FIG. 5a. The second half portion 258 includes a third side portion 266, a fourth side portion 268, and a second joining portion 270. The third side portion 266 is coupled to the fourth side portion 268 via the second joining portion 270. The second half portion 258 has a U-shape with smooth profile. The profile and shape of the second half portion 258 may vary depending on the profile of the core and the type of transformer.

FIG. 5c is a diagrammatic illustration of a core tube 250 in accordance with the exemplary embodiments of FIGS. 5a and 5b. In the illustrated embodiment, the core tube 250 is formed by interleaving the first half portion 256 and the second half portion 258 as discussed herein. The final core tube 250 in this example shows an oval shape, however other shapes are contemplated including a circle.

FIG. 6 is a diagrammatic illustration of a core tube 180 in accordance with yet another exemplary embodiment. In one embodiment, the core tube 180 has a first half portion 186 and a second half portion 188. The first half portion 186 includes a first side portion 190, a second side portion 192, and a first joining portion 194. The first side portion 190 is coupled to the second side portion 192 via the first joining portion 194. Similarly, the second side portion 188 includes a third side portion 196, a fourth side portion 198, and a second joining portion 200. The third side portion 196 is coupled to the fourth side portion 198 via the second joining portion 200.

In the illustrated exemplary embodiment, each of the first side portion 190 and the second side portion 192 are tapered from proximate end to distal end. In the illustrated embodiment, the first side portion 190 has a length “L-1SP1” and the second side portion 192 has a length “L-2SP1”. The first side portion 190 is tapered from proximate end 205 to distal end 203 along the length “L-1SP1”. The second side portion 192 is tapered from proximate end 208 to distal end 206 along the length “L-2SP1”.

Similarly, in illustrated exemplary embodiment, the third side portion 196 and the fourth side portion 198 are tapered from proximate end to distal end. In the illustrated embodiment, the third side portion 196 has a length “L-3SP1” and the fourth side portion 198 has a length “L-4SP1”. The third side portion 196 is tapered from proximate end 212 to distal end 211 along the length “L-3SP1”. The fourth side portion 198 is tapered from proximate end 216 to distal end 214 along the length “L-4SP1”.

In the illustrated embodiment, the first half portion 186 is coupled to the second half portion 188 in an interleaved manner to form the core tube 180. The core tube 180 is assembled surrounding a core 102 (refer to FIG. 3). The interleaved manner includes the first side portion 190 disposed outside and overlapping relative to the third side portion 196 and the second side portion 192 disposed inside and overlapping relative to the fourth side portion 198.

Embodiments of the present techniques discussed herein eliminate gaps between the core tube and the core and/or between the core tube and the winding. Also, the exemplary core tube provides uniform stress distribution between the core and the windings resulting in a longer life for the transformer. The exemplary core tube also allows a user to easily decouple the plurality of halves of the core tube during maintenance and repair.

While certain features have been illustrated and described herein, many modifications and changes will occur to those skilled in the art. It is, therefore, to be understood that the appended claims are intended to cover all such modifications and changes as fall within the true spirit of the invention.

1. A core tube for a transformer, the core tube comprising:
a first half portion comprising a first side portion, a first joining portion, and a second side portion coupled to the first side portion via the first joining portion; wherein the first side portion is longer than the second side portion or vice versa; and
a second half portion coupled to the first half portion in an interleaved manner; wherein the second half portion comprises a third side portion, a second joining portion, and a fourth side portion coupled to the third side portion via the second joining portion; wherein the third side portion is longer than the fourth side portion or vice versa.

2. The core tube of claim 1, wherein the interleaved manner comprises the first side portion disposed outside and overlapping relative to the third side portion and the second side portion disposed inside and overlapping relative to the fourth side portion.

3. The core tube of claim 1, wherein the interleaved manner comprises the first side portion disposed inside and overlapping relative to the third side portion and the second side portion disposed outside and overlapping relative to the fourth side portion.

4. The core tube of claim 1, wherein each among the first and the second halve portions are substantially U-shaped.

5. The core tube of claim 1, wherein each among the first side portion and the second side portion has a first width and the first joining portion has a second width approximately twice the first width.

6. The core tube of claim 1, wherein each among the third side portion and the fourth side portion has a first width and the second joining portion has a second width approximately twice the first width.

7. The core tube of claim 1, wherein each among the first side portion, the second side portion, the third side portion, and the fourth side portion are tapered from a proximate end to a distal end.

8. The core tube of claim 1, wherein each among the first half portion and the second half portion comprises thermoplastics or thermosets.

9. A transformer, comprising:
a core;
a core tube disposed surrounding the core, wherein the core tube comprises:
a first half portion comprising a first side portion, a first joining portion, and a second side portion coupled to the first side portion via the first joining portion; wherein the first side portion is longer than the second side portion or vice versa; and
a second half portion coupled to the first half portion in an interleaved manner; wherein the second half portion comprises a third side portion, a second joining portion, and a fourth side portion coupled to the third side portion via the second joining portion; wherein the third side portion is longer than the fourth side portion or vice versa; and
a plurality of windings wound around the core tube, wherein the windings form at least one primary winding and at least one secondary winding.

10. The transformer of claim 9, wherein the interleaved manner comprises the first side portion disposed outside and overlapping relative to the third side portion and the second side portion disposed inside and overlapping relative to the fourth side portion.

11. The transformer of claim 9, wherein the interleaved manner comprises the first side portion disposed inside and overlapping relative to the third side portion and the second side portion disposed outside and overlapping relative to the fourth side portion.

12. The transformer of claim 9, wherein each among the first side portion, the second side portion, the third side portion, and the fourth side portion are tapered from a proximate end to a distal end.

13. The transformer of claim 9, wherein each among the first and the second halve portions are substantially U-shaped.

14. A method of assembling a core tube for a transformer, the method comprising:
disposing a first half portion and a second half portion of the core tube, surrounding a core; and
coupling the first half portion to the second half portion in an interleaved manner;
wherein the first half portion includes a first side portion, a first joining portion, and a second side portion coupled to the first side portion via the first joining portion; wherein the first side portion is longer than the second side portion or vice versa; wherein the second half portion includes a third side portion, a second joining portion, and a fourth side portion coupled to the third side portion via the second joining portion; wherein the third side portion is longer than the fourth side portion or vice versa.

15. The method of claim 14, wherein the detachably coupling comprises disposing the first side portion outside and overlapping relative to the third side portion and the second side portion inside and overlapping relative to the fourth side portion.

16. The method of claim 14, wherein the detachably coupling comprises disposing the first side portion inside and overlapping relative to the third side portion and the second side portion outside and overlapping relative to the fourth side portion.

17. The method of claim 14, wherein the detachably coupling comprises sliding the first side portion relative to the second side portion in the interleaved manner, or vice versa.

18. A method of manufacturing a core tube for a transformer, the method comprising:
manufacturing a plurality of halve portions; wherein each half portion includes one side portion, a joining portion, and another side portion coupled to the one side portion via the joining portion; wherein the one side portion is longer than the other side portion or vice versa; wherein each among the one side portion and the other side portion has a first width and the joining portion has a second width twice the first width.

19. The method of claim 18, wherein the manufacturing comprises forming each among the first side portion and the second side portion tapered from a proximate end to a distal end.

20. The method of claim 18, wherein the manufacturing comprises forming the each half portion having a U-shape.

21. The method of claim 18, wherein the manufacturing comprises extrusion, compression molding, or thermoforming the plurality of halve portions.
